(19) United States
(12) Patent Application Publication
(10) Pub. No.: US 2010/0064982 A1
(43) Pub. Date: Mar. 18, 2010

(54) Animal Mouse Toy

(76) Inventor: Frank White, Chicago, IL (US)

Correspondence Address: ADVANTIA LAW GROUP, 9035 SOUTH 1300 EAST, SUITE 200, SANDY, UT, 84094, US

(21) Appl. No.: 12/211,999

(22) Filed: Sep. 17, 2008

(51) Int. Cl. A01K 29/00

(52) U.S. Cl. 119/707

(57) ABSTRACT

An animal mouse toy for cats, comprising: a main body having an oblong shape which includes: a front region having an underside portion and a front portion, wherein the underside portion and the front portion are each substantially V-shaped; a rear region; and a middle region disposed between the front portion and the rear portion. A tail member extends outwardly from the rear region. The animal mouse toy includes a forward motion system which includes a motor device, a power module, an on/off switch, and at least one wheel. The animal mouse toy further includes a forward motion maintenance system which includes: a weight device coupled to the underside of the main body; and a plurality of elongated members extending outwardly from opposing sides of the front region and oriented substantially orthogonal thereto. A container is included on the main body for catnip and/or other objects.

### BACKGROUND OF THE INVENTION

1. Field of the Invention

The present invention relates to animal mouse toys, specifically an animal mouse toys for cats.

2. Description of the Related Art

In the related art, pet toys and/or other animal accessories are often used to entertain and even provide necessary exercise for household pets. Typically, cats are the laziest of the household pets and are the most prone to become obese.

In order to promote exercise and playful activity among the feline population, as well as other household pets, mobile and/or power driven animal toys have been developed. These power driven animal toys allow for a household pet to play and/or exercise while not needing an owner or other pet around. However, during the course of use, many of the mobile and/or power driven animal toys may hit into a wall, furniture, and/or other obstruction. This may cause the mobile animal toy to be turned over and/or prevent further movement of the mobile mouse toy. Some improvements have been made in the field. Examples include but are not limited to the references described below, which references are incorporated by reference herein:

U.S. Pat. No. 4,272,916, issued to Giordano, discloses a wheel-supported figure toy in the form of a pup has a driving motor to propel it in a forward direction. Proximity sensors in the form of capacitor plates control operation of the motor. When a child's hand or the like approaches the rear of the figure, the capacitance of a first capacitor arrangement is changed and the motor is started and propels the figure forwardly for a predetermined time, then stops. If the hand is placed under the pup's chin, a second capacitor arrangement causes the pup to follow the hand. An RC network determines the time the motor is in operation by holding a monostable vibrator on, which keeps the motor running, after it is started, for the predetermined time interval. The toy also has a sounding device that operates when the figure is being propelled.

U.S. Pat. No. 4,941,857, issued to Fujimaki, discloses an animal toy capable of electrically producing body movements are switched on and off by a pair of spaced apart electrical contacts disposed on a bottom surface of the animal toys. When a toy is placed in an individual's hand, the two contacts are bridged and an electrical circuit within the animal toy is closed to activate either a vibration producing mechanism.

U.S. Pat. No. 5,221,226, issued to Park, discloses a movable toy having a vibrator arrangement adapted to be mounted in a toy body. The vibrator includes one or more vibrating elements eccentrically mounted on the shaft of a motor that is energized into rotation by a switch. The rotation of the eccentrically mounted vibrating element causes the toy to vibrate and move in different directions depending on how the vibrator is mounted in the toy body. The toy body has an outer portion in which is embedded dyed artificial hair. The bottom portion of the toy body is made of a smooth material for ease of movement of the toy along a contacting surface.

U.S. Pat. No. 6,039,628, issued to Kusmiss et al., discloses a self-mobile cat toy capable of simulating intermittent life includes a rodent-like shell partially or wholly containing an electrical power source mechanically and electrically connected to motor-powered wheels or a tread mechanism for moving along the ground. The power circuit includes an orientation-dependent switch which is closed or open depending on its orientation, so that when played with by a cat, the toy will cease to move in certain orientations and begin to move when pawed into other orientations. In another embodiment the powered wheels or tread are replaced by a vibrating mechanism. In yet other embodiments the cat toy is externally controlled by the pet owner, through either a long cable with a switch at the end or through a radio or ultrasonic transmitter-receiver system.

U.S. Pat. No. 6,155,905, issued to Truax, discloses a cat toy formed from a soft, breathable material which will pass the aroma of catnip. A closable flexible pouch for catnip is formed at the bottom of the body and a vibratory motor is positioned in contact with the pouch to impart vibratory energy to the pouch and propel the cat toy. The vibratory motor may be activated by a pull cord which extends externally of the body of the cat toy.

U.S. Design Pat. No. D373,662, issued to Box, discloses an ornamental design of a speedy mouse cat toy.

The inventions heretofore known suffer from a number of disadvantages which include: being unstable, being prone to tip over, becoming lodged and/or becoming obstructed by furniture, walls, and/or other obstructions.

What is needed is an animal mouse toy that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available animal mouse toys. Accordingly, the present invention has been developed to provide an animal mouse toys for cats.

In one embodiment, the animal mouse toy for cats may comprise a main body having an oblong shape. The main body may main include: a front region having an underside portion and/or a front portion, wherein the underside portion and/or the front portion are each substantially V-shaped; a rear region; and/or a middle region disposed between the front portion and/or the rear portion. The animal mouse toy for cats may also include a tail member extending outwardly from the rear region.

In another embodiment, the animal mouse toy for cats may comprise a forward motion system, configured cause movement of the animal mouse toy, and/or a forward motion maintenance system. The forward motion maintenance system may include: a weight device coupled to the underside of the main body; and/or a plurality of elongated members, composed of a substantially rigid material, extending outwardly from opposing sides of the front portion and/or oriented substantially orthogonal thereto.

In yet another embodiment, the animal mouse toy may include a main body wherein the front portion and/or the underside portion are one contiguous V-shaped curve. Additionally, the substantially V-shaped nose may be encased in a flexible rubber-like material.

In still another embodiment, the forward motion system may include at least one wheel disposed on the underside of the main body; a motor device, configured to cause movement of the animal mouse toy; a power module, configured to provide energy to the motor device; and/or an on/off switch, configured to allow a user to turn the device on or off. The power module may further comprise a battery. The motor device may further comprise a slow speed and/or a fast speed.

In yet another embodiment, the animal mouse toy for cats may further comprise a container coupled to the main body, configured to receive at least one object.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of an animal mouse toy, according to one embodiment of the invention;

FIG. 2 is a bottom perspective view of an animal mouse toy, according to one embodiment of the invention;

FIG. 3 is a perspective view of an animal mouse toy, according to one embodiment, of the invention; and

FIG. 4 is block diagram of an animal mouse toy, according to one embodiment of the invention.

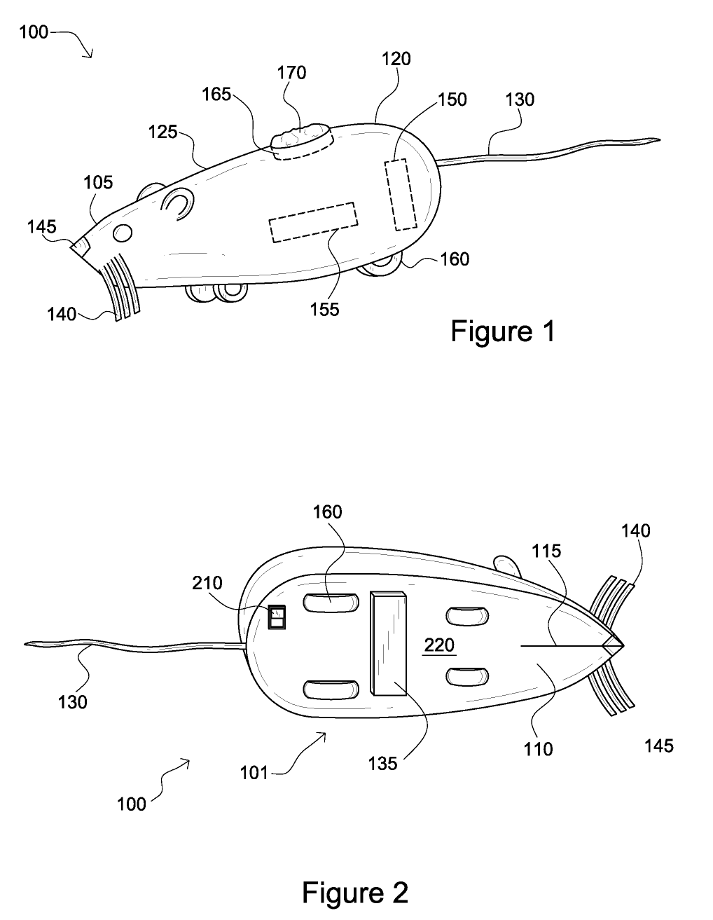

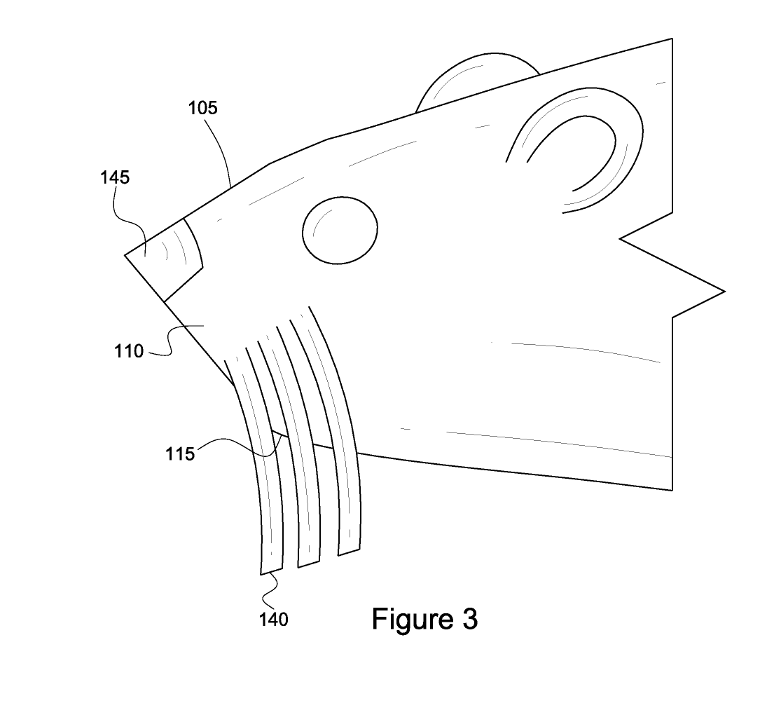

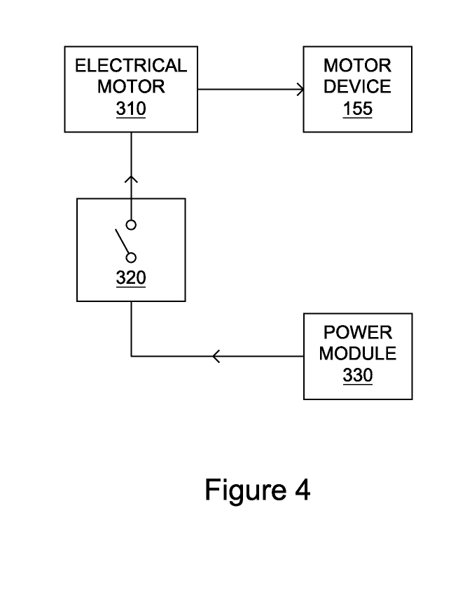

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Looking to the figures, there is an animal mouse toy 100 including a main body 101. The main body 101 has an oblong shape and includes: a front region 105, a rear region 120, and a middle region 125 disposed between the front region 105 and the rear region 125. The front region 105 has an underside portion 110 and a front portion 115, wherein the underside portion 110 and the front portion 115 are each substantially V-shaped. In being V-shaped, the front region 105 extends forwardly from the middle region 125, opposing sides of the front region 105 converging to become progressively narrower until coming together in a substantial V-shape at the front portion 115. In being V-shaped, the underside portion 110 opposing sides of the front region 105 and/or front portion 115 extend downwardly, converging to become progressively narrower until coming together in a substantial V-shape. In being substantially V-shaped, the opposing sides of the front portion 115 may converge together form a pointed V. Similarly, opposing sides of the underside portion may converge together to form a pointed V. Additionally, opposing sides of the front portion 115 and opposing sides of the underside portion 110 may converge together forming a more rounded and/or dull end. Alternatively, the front portion 115 and the underside portion 110 may form a substantial U-shape, with opposing sides being more curved. The main body 101 may be made from a varied of substances and/or material contemplated in the art. Some non-limiting examples of these include: soft rubber, hard rubber, plastic, ceramic, and/or so forth. The main body may also comprise a soft, padded material which can be safe for a household pet's claws. Alternatively, the front portion 115 and the underside portion 110 may be one contiguous V-shaped curve.

In an alternative embodiment, the front region may be shaped to mirror the hull and/or bottom of a boat. Examples of which are found in U.S. Patent Publications US 2001/0047747 and US 2001/0001941, incorporated herein by reference.

Still looking to the figures, the illustrated animal mouse toy 100 includes a tail member 130 extending outwardly from the rear region 120. The tail member 130 may be coupled to the rear region 120; for example, by hook and loop fastener, an adhesive material and/or so forth. Additionally, the tail member 130 may be manufactured as part of mold of the main body 101 which incorporates the tail member 130 therein. The tail member 130 may be composed of a variety of materials contemplated in the art. Some non-limiting examples of these materials include: soft rubber, hard rubber, plastic, ceramic, and/or so forth.

Still looking to the figures, the illustrated animal mouse toy 100 includes a forward motion system, configured to cause movement of the animal mouse toy 100. The forward motion system includes: a wheel 160 disposed on the underside 220 of the main body 101; a motor device 155 coupled to the main body 101 and in communication with the wheel 160, and configured to cause movement of the animal mouse toy 100; a power module 330, configured to provide energy to the motor device 155; and an on/off switch 210, configured to allow a user to turn the motor device 155 on or off.

Again looking to the figures, the animal mouse toy 100 includes a wheel 160 which is disposed on the underside 220 of the main body 101. The wheel 160 may be made of a variety of materials contemplated in the art. Some non-limiting examples include: soft rubber, hard rubber, plastic, ceramic, and/or so forth. Additionally, the animal mouse toy 100 may include a plurality of wheels 160, each substantially identical to one another. The plurality of wheels 160 may be fully exposed on the exterior of the underside 220 and/or be partially disposed in the interior of the main body 101.

Still looking the figures, the forward motion system includes a motor device 155 coupled to the main body 101 and in communication with the wheel 160, and configured to cause movement of the animal mouse toy 100. The motor device 155 may be internally disposed in the interior of the main body 101 and/or may be coupled to exterior of the main body 101. A person skilled in the art would recognize there is a multitude of motor devices available. Indeed, there is a multitude of motor devices available, like those from www.hobbyengineering.com/SectionM.html.

As illustrated in the figures, the forward motion system also includes a power module 330 in communication with the motor device 155, and configured to provide energy to the motor device 155. The power module 330 may be in communication with the motor device 155 via a circuit which includes a first switch 320. The first switch 320 when closed will enable energy to flow to the motor device 155. The first switch 320 may further be connected to an on/off power switch 210 disposed on the exterior of the animal mouse toy 100. The power module 330 may further comprise be a variety of different cells or batteries 150 matched to the power requirements of the motor device 155. Motor devices 155 are available to run at various voltages, such as the 1.5 Volts of emf provided by conventional AAA, AA, C, or D batteries. The power source 18 could be of the rechargeable type or could consist of solar cells and/or a conventional battery, such as AA, AAA, and/or so forth.

In another embodiment, the motor device 155 includes two speeds: fast and super fast. The motor device 155 includes a second switch, substantially identical to the first switch 320. The second switch enables the user the energy from one speed to another. Still looking to the figures, the illustrated mouse toy includes a forward motion maintenance system. A person skilled in the art would recognize there is a multitude of motor devices available. Indeed, there is a multitude of motor devices available, like those from www.hobbyengineering.com/SectionM.html.

The forward motion maintenance system includes a weight device 135 coupled to the underside 220 of the main body; and a plurality of elongated members 140 which extend outwardly from the opposing sides of the front region and oriented substantially orthogonal thereto. The weight device 135 may be coupled on the exterior and/or interior of the underside 220 of the main body. Indeed, the weight device 135 may be disposed partially on the exterior and interior of the main body 101. The weight device 135 may be any weight device contemplated in the art. The weight device 135 may be coupled to the main body 101 in any manner contemplated in the art, such as an adhesive material, nail or screw, hook and loop, and/or so forth. Furthermore, the weight device 135 may be composed of any substantially heavy material, such as, but not limited to, steel, metal, ceramic, and/or so forth.

As illustrated in the figures, the forward motion maintenance system further includes a plurality of elongated members 140, composed of a substantially rigid material, extending outwardly from opposing sides of the front region and oriented substantially orthogonal thereto. In being substantially rigid, the material of the plurality of elongated members 140 may be completely rigid, for example, inflexible. Additionally, the material of the plurality of elongated members 140 may be somewhat flexible. The plurality of elongated members 140 may be coupled to the front region; for example, by hook and loop fastener, an adhesive material and/or so forth. Additionally, the plurality of elongated members 140 may be manufactured as part of mold of the main body which incorporates the plurality of elongated members 140 therein. The plurality of elongated members 140 may be composed of a variety of material contemplated in the art. Some non-limiting examples of the material of the plurality of elongated members 140 include: rubber, hard rubber, plastic, ceramic, steel, and/or so forth.

Still looking to the figures, the illustrated animal mouse toy 100 includes a substantially V-shaped front portion 115 that is encased by a flexible, rubber-like material 145. The flexible, rubber-like material 145 maybe any material contemplated in the art. Some non-limiting examples of flexible, rubber-like material 145 include: soft rubber, hard rubber, foam, and/or so forth. The flexible, rubber-like material may be coupled to the front portion by any means contemplated in the art, such as an adhesive material.

In an alternative embodiment, the substantially V-shaped front portion 115 is composed entirely of a flexible type material. The substantially V-shaped front portion 115 being composed of a flexible material may assist in preventing the forward movement of the animal mouse toy 100 from becoming obstructed and/or stopped. Some non-limiting examples of a flexible type material include: soft rubber, hard rubber, foam, and/or so forth.

Again looking to the figures, the illustrated animal mouse toy 100 includes a container 165 coupled to the main body 101, configured to receive at least one object 170. The container 165 may be coupled to the main body 101 in a variety of ways. In one non-limiting example, the container is inset into the main body 101 such that an open cavity is formed. The interior of the open cavity may allow for a variety of objects to be placed in the interior, such as cat treats, cat food, and/or so forth. The container may be coupled to the main body 101 in any manner contemplated in the art. Some non-limiting examples of coupling include: adhesive material, nail, screw, and/or so forth. Alternatively, the container 165 may come pre-formed with the main body 101 in a manufacturers mold.

Advantageously, in one embodiment, the animal mouse toy 100 includes the forward motion maintenance system. The forward motion maintenance system, in conjunction with the shape of the underside portion 110 and the front portion 115 can assist in preventing walls, furniture, and other obstructions from stopping and/or flipping over the animal mouse toy. For example, when the animal mouse toy 100 approaches a wall and/or other obstruction, the shape of the front portion 115 and the underside portion 110 can bias the animal mouse toy's 100 movement to one side or the other. The weight device 135, in conjunction with the plurality of elongated members 140, may work together in assisting the animal mouse toy 100 in keeping the plurality of wheels 160 on the ground; thus, maintaining forward movement of the animal mouse toy 100. Further, the plurality of elongated members 140 being on opposing sides can bias the animal mouse toy 100 from overturning on either side; while the weight device 135 can assist to maintain the plurality of wheels 160 on ground. This, together with the unique shape of each of the front portion 115 and the underside portion 110, can assist in maintaining forward motion of the animal mouse toy 100.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is also envisioned that the animal mouse toy 100 may come in a variety of sizes, lengths, and/or colors. Some non-limiting examples include: small, medium, large, and/or so forth.

It is also envisioned that the animal mouse toy 100 may come with a logo disposed on the exterior of the mouse toy. In a non-limiting example, a pet company may wish to promote their company by placing their logo on the animal mouse toy 100.

It is expected that there could be numerous variations of the design of this invention. A non-limiting example of a design includes: drawings and/or art on the mouse toy simulating mouse features, such as fur, eyes, and/or so forth.

Finally, it is envisioned that the components of the device may be constructed of a variety of materials. Some non limiting examples of materials include: soft rubber, hard rubber, foam, ceramic, and/or so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An animal mouse toy for cats, comprising:
a main body having an oblong shape, including:
a front region having an underside portion and a front portion, wherein the underside portion and the front portion are each substantially V-shaped;
a rear region; and
a middle region disposed between the front portion and the rear portion;
a tail member extending outwardly from the rear region;
a forward motion system, configured cause movement of the animal mouse toy, and
a forward motion maintenance system, including:
a weight device coupled to the underside of the main body; and
a plurality of elongated members, composed of a substantially rigid material, extending outwardly from opposing sides of the front region and oriented substantially orthogonal thereto.

2. The animal mouse toy of claim 1, wherein the front portion and the underside portion are one contiguous V-shaped curve.

3. The animal mouse toy of claim 1, wherein the substantially V-shaped front portion is encased in a flexible rubber-like material.

4. The animal mouse toy of claim 1, wherein the forward motion system includes:
a wheel disposed on the underside of the main body;
a motor device coupled to the main body and in communication with the wheel, and configured to cause movement of the animal mouse toy;
a power module, configured to provide energy to the motor device; and
an on/off switch, configured to allow a user to turn the device on or off.

5. The animal mouse toy of claim 4, wherein the power module comprises a battery.

6. The animal mouse toy of claim 4, wherein in the motor device comprises a slow speed and a fast speed.

7. The animal mouse toy of claim 1, further comprising a container coupled to the main body, configured to receive at least one object.

8. An animal mouse toy for cats consisting essentially of:
a main body having an oblong shape, including:
a front region having an underside portion and a front portion, wherein the underside portion and the front portion are each substantially Vee shaped;
a rear region; and
a middle region disposed between the front portion and the rear portion;
a tail member extending outwardly from the rear region;
a forward motion system, configured cause movement of the animal mouse toy, and
a forward motion maintenance system, including:
a weight device coupled to the underside of the main body; and
a plurality of elongated members, composed of a substantially rigid material, extending outwardly from opposing sides of the front region and oriented substantially orthogonal thereto.

9. The animal mouse toy of claim 8, wherein the front portion and the underside portion are one contiguous V-shaped curve.

10. The animal mouse toy of claim 8, wherein the substantially V-shaped front portion is encased in a flexible rubber-like material.

11. The animal mouse toy of claim 8, wherein the forward motion system includes:
a wheel disposed on the underside of the main body;
a motor device coupled to the main body and in communication with the wheel, and configured to cause movement of the animal mouse toy;
a power module, configured to provide energy to the motor device; and
an on/off switch, configured to allow a user to turn the device on or off.

12. The animal mouse toy of claim 11, wherein the power module comprises a battery.

13. The animal mouse toy of claim 11, wherein in the motor device comprises a slow speed and a fast speed.

14. The animal mouse toy of claim 8, further comprising a container coupled to the main body, configured to receive at least one object.
